(19) United States
(12) Patent Application Publication
(10) Pub. No.: US 2025/0028997 A1
(43) Pub. Date: Jan. 23, 2025

(54) CALIBRATION USING DIFFERENTIAL MACHINE LEARNING

(71) Applicant: Wells Fargo Bank, N.A., San Francisco, CA (US)

(72) Inventors: Arun Kumar Polala, Jersey City, NJ (US); Bernhard Hientzsch, Flushing, NY (US)

(21) Appl. No.: 18/353,572

(22) Filed: Jul. 17, 2023

(51) Int. Cl. G06N 20/00

(52) U.S. Cl. CPC G06N 20/00

(57) ABSTRACT

This disclosure describes techniques for calibrating parameters for a model of interest. In one example, this disclosure describes identifying, based on a textual description, a model that generates an output based on a set of inputs; selecting a first plurality of parameter values; assembling a set of training samples by observing outputs generated by the model in response to each of the first plurality of parameter values; training a surrogate model, wherein the surrogate model is trained to predict outputs of the model; generating, using the surrogate model, predicted outputs of the model, wherein each of the predicted outputs of the model is based on a different parameter value in a second plurality of parameter values; selecting, based on the predicted outputs of the model, a desired parameter value; and applying the model, using the desired parameter value, to predict a value of interest for an input value.

### TECHNICAL FIELD

This disclosure relates to computing systems, and more specifically, to techniques for training a supervised learning model.

### BACKGROUND

Supervised machine learning involves a computing system learning a function that maps inputs to outputs based on a set of labeled training examples. Often, the function operates differently depending on various parameters. Finding the function that operates best for a given purpose may involve optimizing parameters that define the operation of the function. Such parameters may include weights, biases, regularization coefficients, and others. The process of finding the optimal values for parameters is sometimes referred to as calibration or parameter optimization.

Surrogate models are simplified representations of a complex system that can approximate the input-output behavior of the complex system. Surrogate models are sometimes used when the original complex system is too expensive, time-consuming, or impractical to evaluate directly. For example, surrogate models are helpful when performing repeated simulations, where the number of simulations is large enough to make using the original complex system too costly or time-consuming.

### SUMMARY

This disclosure describes applying differential machine learning techniques to calibrate parameters for a complex model, where that complex model that may be costly and/or time-consuming to evaluate. Such techniques involve, for example, parametric calculation of output values through least squares regression regularized with derivatives of those output values with respect to parameters and state as conditional expectations.

This disclosure also describes a framework (or in some examples, a “simulation and calibration framework”) that is capable of transforming a simple model script into a set of calibrated parameters to be used with the complex model, with little or no additional input required from a user or model designer. In some examples, the simulation and calibration framework interprets and/or parses the script, uses characterization of the values of interest as conditional expectations, and performs regularization on simulations of the complex model to obtain surrogate models representing an approximation of that more complex model. Those surrogate models are designed to be capable of approximating the values of interest that would be generated by the more complex model, yet are fast enough for use in parametric calibration analysis.

This disclosure describes operations performed by a computing system. In one specific example, this disclosure describes a method comprising identifying, by a framework and based on a textual description, a model that generates an output based on a set of inputs, wherein the inputs include a plurality of parameters; selecting, by the framework, a first plurality of parameter values; assembling, by the framework, a set of training samples by observing outputs generated by the model in response to each of the first plurality of parameter values; training, by the framework and based on the set of training samples, a surrogate model, wherein the surrogate model is trained to predict outputs of the model; generating, by the framework and using the surrogate model, predicted outputs of the model, wherein each of the predicted outputs of the model is based on a different parameter value in a second plurality of parameter values; selecting, by the framework and based on the predicted outputs of the model, a desired parameter value; and applying the model, using the desired parameter value, to predict a value of interest for an input value.

In another example, this disclosure describes a system comprising a storage system and processing circuitry having access to the storage system, wherein the processing circuitry is configured to carry out operations described herein. In yet another example, this disclosure describes a computer-readable storage medium comprising instructions that, when executed, configure processing circuitry of a computing system to carry out operations described herein.

The details of one or more examples of the disclosure are set forth in the accompanying drawings and the description herein. Other features, objects, and advantages of the disclosure will be apparent from the description and drawings, and from the claims.

### BRIEF DESCRIPTION OF THE DRAWINGS

FIG. 1 is a conceptual diagram illustrating an example system for calibrating parameters for a model, in accordance with one or more aspects of the present disclosure.

FIG. 2A through FIG. 2C illustrate example model scripts in accordance with one or more aspects of the present disclosure.

FIG. 3 is a block diagram illustrating an example system for calibrating parameters for a model, in accordance with one or more aspects of the present disclosure.

FIG. 4 is a conceptual diagram illustrating an example system that applies the output of a model to a downstream system to control the operation of the downstream system in accordance with one or more aspects of the present disclosure.

FIG. 5 is a flow diagram illustrating operations performed by an example framework, in accordance with one or more aspects of the present disclosure.

### DETAILED DESCRIPTION

Differential Machine Learning (DML) is an approach to regularization that can be used to prevent overfitting when training a machine learning model. DML makes use of path-wise differentials of Monte Carlo samples in addition to path-wise Monte Carlo samples in training neural networks. In other words, DML involves not only calculating output values “y” for a given input value “x,” but DML also makes use of the gradient of y with respect to x, which might be expressed as dy/dx or δy/δx.

Training samples used to train a machine learning model (e.g., a deep neural network) might therefore include not only values of “y” and “x,” as is conventional, but also values of δy/δx. These path-wise differentials help neural networks learn the loss function better and thereby improve convergence, often enabling convergence to occur faster and/or with less samples. Derivatives for sensitivities or gradients can often be computed quickly through techniques like algorithmic differentiation or adjoint algorithmic differentiation.

The differential machine learning approach is to minimize least squares subject to regularization by derivatives as follows:

$${{Θ}_{N}^{* , DML} = arg {min}_{{Θ}_{N}} E [ \vert Y - N ( X ; {Θ}_{N} ) {\vert}^{2} + {\sum }_{i , j} {λ}_{i , j} \vert {DY}_{i , j} - \frac{\partial {N ( X ; {Θ}_{N} )}_{i}}{\partial {X}_{j}} \vert}^{2} ]$$

$${e}^{* , DML} ( X ) : = N ( X ; {Θ}_{N}^{* , DML} )$$

$$and$$

$${DY}_{ij} = \frac{\partial {Y}_{i}}{\partial {X}_{j}}$$

As described herein, the X vector can contain model and contract parameters in addition to state vectors.

In a finance application, for example, one primary objective might be to approximate price as conditional expectation e(X)=E[Y\X] as a function of X, where:
Given N_{S} joint samples {(Xⁱ, Yⁱ), i=1, . . . , N_{S}}
Each Xⁱ=(Xⱼⁱ, j=1, . . . , N_{X}) where N_{X} is a dimension of X
Each Yⁱ=(Yⱼⁱ, j=1, . . . , N_{Y}) where N_{Y} is a dimension of Y

In the above formulas, Y is a vector of discounted or undiscounted payoffs defined on risk factors modeled by some stochastic process. For example, in the following equation, X could be a vector consisting of initial state S(0), intermediate state S(t), model parameters (ρ, σ), and/or payoff parameters (K):

$${dS}_{t} = μ {S}_{t} d t + σ {S}_{t} {dW}_{t} with Y - max ( {\int }^{T} \text{?} {S}_{t} dt - K , 0 ) or Y = max ( {S}_{T} - K , 0 )$$

$$\text{?} \text{indicates text missing or illegible when filed}$$

Preferably, parameter(s) are chosen so that they are “optimal” in some sense. For example, an optimal parameter value might mean that it tends to maximize Y, such as where Y is a vector of discounted or undiscounted payoffs (e.g., defined on risk factors modeled by some stochastic process). In another example, “optimal” might mean that an optimal parameter is one that causes Y to be minimized (e.g., where Y is a weight value in an avionics application). In other examples, an optimal parameter may cause Y to be generated having some characteristic, such as exceeding a threshold, or representing sufficient strength (e.g., in a physics application).

Differential machine learning techniques can be applied in a number of ways, but as described herein, differential machine learning techniques can be used for calibration or model fitting to optimize selection of parameters for a model of interest. When applied to payoffs from an options contract, for example, differential machine learning can be used to optimize parameters where the processes and functionals for the options contract depend on model parameters (e.g., underlying financial instrument, variance, volatility) and contract parameters (e.g., strike price), respectively. Further information about how differential machine learning can be extended to settings with parameters can be found in Polala & Hientzsch, “Parametric Differential Machine Learning for Pricing and Calibration,” Feb. 6, 2023 (SSRN-id4358439) (hereinafter “Polala & Hientzsch”), which is hereby incorporated by reference.

Calibration or model fitting generally corresponds to finding the best model parameters according to some objective function. Often, calibration is a challenge because performing basic sensitivity analysis, evaluation, and/or testing to optimize parameter values might require a large number of simulations performed by the model. The large number of simulations enable an assessment of how parameters change outputs of the model. Such computer simulations can be expensive, however, both in terms of time (e.g., simulations are time consuming) and cost (e.g., performing a simulation within a reasonable amount of time can require significant computing resources). Accordingly, even basic activities like design exploration, sensitivity analysis, and what-if analysis tend to be impractical when using the full model.

One approach to overcoming these cost and time constraints involves using an approximation model or a “surrogate” model that is a simplified version of the actual or full model. The surrogate model is designed to estimate the output values or other values of interest that the full model would generate if the full model were provided with the same input values and parameters. Importantly, however, the surrogate model is also designed to provide output values or other values of interest much faster than the actual model. Accordingly, the surrogate model tries to approximate the input-output relationship of the true model as closely as possible, but with less computational cost. Yet since the surrogate model is much faster than the full model, it can be used to perform sensitivity analysis, parameter optimization, and other tasks without the time and cost limitations associated with running simulations on the full model. The surrogate model might not provide perfectly accurate predictions of the values of interest, but if the surrogate model provides sufficiently accurate predictions, the surrogate model can be used for calibration effectively.

In the past, approaches to calibration using surrogates have been model-specific, requiring complicated processes to conceive of simplified surrogate models capable of quickly generating approximate output values. Effectively, prior approaches required derivation of simplified surrogate models, generating approximate solutions, implementing fast approximate solvers, and using those solvers wherever needed. Such an approach tends to be time-consuming and complicated, and often requires significant expertise and domain-specific knowledge. Such an approach may also be difficult to accomplish correctly.

A different approach to calibration of parameters is described herein, and involves characterization of values of interest as conditional expectations and regularization on simulations of the full model to obtain surrogate models. In some examples, the surrogate models are deep neural networks that are able to quickly and efficiently produce an approximated quantity of interest, where that approximated quantity of interest is sufficiently accurate for the purposes of calibration of parameters.

Further, techniques are described herein that enable a low-code or no code process of identifying or selecting optimized parameter values based simply on a model script or textual description of the underlying model. The textual description or model script, as described and illustrated herein, may specify various mathematical equations (formatted as simple text), and those equations may include both ordinary and stochastic differential equations. Generally, the model script specifies in text the equations underlying the model, where the equations have a nearly one-to-one correspondence to the mathematical notation familiar to model practitioners. Some domain-specific knowledge may be required to generate the model script, but once it is prepared, techniques described herein can perform most or all of the remaining tasks necessary to generate a set of optimal parameters for the underlying model. Accordingly, in at least some examples, the framework or simulation and calibration framework generates appropriate surrogate models based on the model script, analyzes the surrogate models to evaluate the effect of various parameters, and generates appropriate and/or optimal parameters that can be used with the full model.

Although described herein principally in a financial context, these calibration and differential machine learning techniques can be applied to other fields beyond finance. For example, extending differential machine learning techniques to settings with parameters may be a technique that could also apply to any field in which the value of interest is a conditional expectation of a model, process, or black box that can be simulated. Such scenarios are common in the fields of epidemiology, biology, medicine, physics, finance, and other fields.

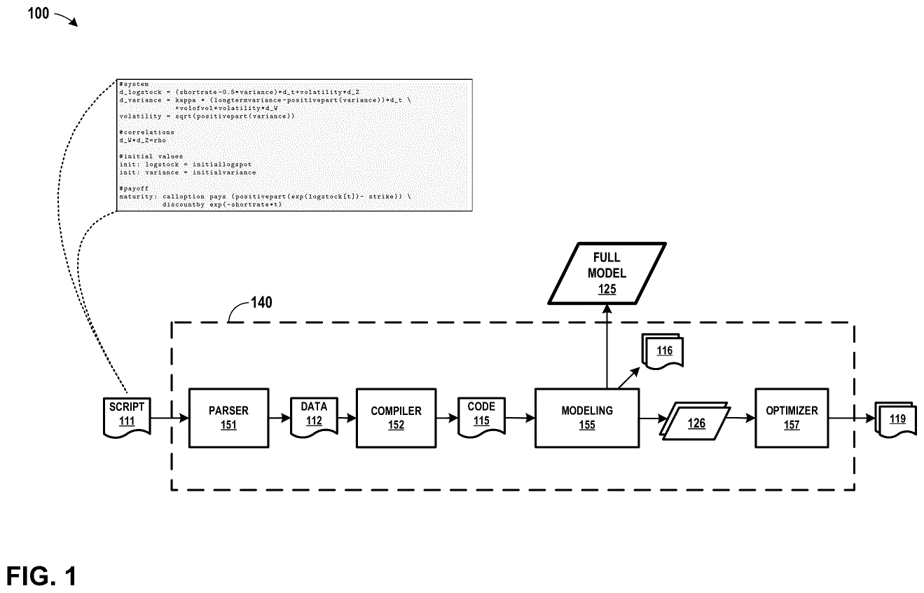

FIG. 1 is a conceptual diagram illustrating an example system for calibrating parameters for a model, in accordance with one or more aspects of the present disclosure. System 100 includes framework 140 (which, in some examples, may be described herein as simulation and calibration framework 140). Framework 140 accepts model script 111 as input and generates optimized parameters 119 for model 125. Model script 111 may be a description of a model specifying equations associated with or underlying a model for which parameters are sought to be selected and/or optimized. As shown in FIG. 1, simulation and calibration framework 140 comprises parser 151, compiler 152, modeling platform 155, and optimizer 157. Modeling platform 155 may, in some examples, include or have access to a commercially-available machine learning platform, such as TensorFlow, Numpy, or PyTorch. Simulation and calibration framework 140 operates, as described herein, to convert model script 111 into optimized parameters 119.

Model 125 may be a relatively high-fidelity model, requiring significant processing resources to generate output values of interest in response to input and parameters. Accordingly, using model 125 to generate such values may be costly and/or time-consuming. As described herein, modeling platform 155 of simulation and calibration framework 140 may interact with model 125 to generate training samples 116 and surrogates 126.

In an example that can be described in the context of FIG. 1, and in accordance with one or more aspects of the present disclosure, simulation and calibration framework 140 may generate code 115. For instance, parser 151 of simulation and calibration framework 140 detects input that it interprets as information about a description of a model or model script 111. Parser 151 parses text included within model script 111 to generate parsed data 112. Parser 151 outputs parsed data 112 to compiler 152. Compiler 152 translates parsed data 112 into code 115. In some examples, parser 151 and/or compiler 152 may use syntax trees or other data structures to generate code 115. In examples where modeling platform 155 includes or applies functionality available in TensorFlow, code 115 may include various computational graphs or other data structures that can be used to train machine learning models or neural networks.

Modeling platform 155 may execute and/or process code 115 to generate training samples 116. For instance, continuing with the example being described in the context of FIG. 1, modeling platform 155 uses code 115, which was derived from model script 111, to instantiate, initialize, or identify model 125. Modeling platform 155 interacts with model 125 to prepare for executing simulations. Modeling platform 155 selects a set of design parameters from a parameter space. Modeling platform 155 causes model 125 to predict an output or other quantity of interest based on a state and each of the selected parameters. Modeling platform 155 repeats the process of selecting parameters and using the selected parameters to generate an output from model 125. Eventually, through this process, modeling platform 155 assembles a set of training samples 116 that include an output value from model 125 (e.g., a payoff for a caplet or other financial instrument) and the input values and/or parameters that produced that output value (e.g., a state, identification of a financial instrument, strike price, floor, cap, maturity). In some examples, the training data may also include derivatives of the output value or other value of interest with respect to parameters and state.

While generating training samples 116, modeling platform 155 may, in some examples, apply certain methodologies when selecting parameters for the training samples 116. For example, while modeling platform 155 may randomly or arbitrarily select samples of design parameters from the parameter space, other methods may be more effective. For instance, it may be preferable to have training samples 116 that include parameters that are spread evenly across the parameter space, thereby ensuring a more representative sample of input-output values from all regions of the parameter space. Space-filling sampling schemes can be used for this purpose.

In other examples, different schemes for selecting samples may be used. For instance, samples may be selected and/or adjusted based on how the magnitude of the conditional expectation of an output value Y, given a set of parameters, varies across different parameters. Specifically, it turns out that trained surrogates tend to approximate the conditional expectations well for parameter settings for which the conditional expectations have the largest magnitude but not for parameters where the conditional expectations have smaller magnitudes. This is often not desirable because in calibration and other parametric pricing settings, it is important to achieve a certain relative accuracy for model parameters across the parameter range.

Accordingly, an adaptive sampling scheme may be employed to address this issue. For instance, in one such approach, modeling platform 155 first parametrically or non-parametrically estimates the magnitude of the conditional expectation of Y across the parameter domain. Modeling platform 155 then constructs marginal (or bivariate) parameter distributions resulting in an approximately constant expectation of Y across the parameter domain. For model parameters ‘a’ and ‘b,’ for example, the E[Y| a, b] may vary significantly over the parameter range of ‘b’ and whereas across parameter ‘a’ it does not vary significantly. To mitigate the impact of this magnitude difference, modeling platform 155 constructs an adaptive sampling distribution P for parameter ‘b’ such that P is directly proportional to 1/E[.|b]. In this example, modeling platform 155 can approximate the marginal expectations E[.|b] by binning the samples by the b parameter and computing bin averages. Using these averages, modeling platform 155 computes a cubic spline fit to get a smooth approximation of 1/E[.|b]. Finally, modeling platform 155 scales the cubic spline fit appropriately so that it integrates to one and can be used as sampling distribution.

Using the adaptive sampling scheme described above, modeling platform 155 is able to sample parameter sets in a way that leads to smaller conditional expectations more often. Modeling platform 155 can then approximate those parameter regions better than with a uniform distribution. This will also lead to fewer samples in those parameter regions leading to larger conditional expectations, which may lead to some degradation of approximation quality in those areas of the parameter space. In general, however, the approach described above can be used to achieve good quality surrogates with less sampling.

Once sufficient training samples 116 are generated, simulation and calibration framework 140 may use training samples 116 to generate surrogates 126. For instance, returning again to the example being described in the context of FIG. 1, modeling platform 155 accesses training samples 116. Modeling platform 155 trains a model (e.g., a deep neural network) to predict values of interest that model 125 would generate, if the same input and parameter values were input to model 125. When training models, modeling platform 155 may use differential machine learning techniques to minimize least squares subject to regularization by derivatives output values with respect to parameters and state. To perform the training, modeling platform 155 may use TensorFlow, Numpy, PyTorch, or other machine learning tools. As a result of the training, modeling platform 155 generates one or more surrogates 126. Each of surrogates 126 may be a neural network trained to predict the output values that model 125 would be expected to generate using the same inputs and parameters.

Simulation and calibration framework 140 may use surrogates 126 to generate optimized parameters 119. For instance, again with reference to the example being described, optimizer 157 executes a large number of simulations using surrogates 126, and observes and records the outputs. Optimizer 157 performs a sensitivity analysis to assess how differing parameters change outputs of model 125. Eventually, and based on the analysis of the outputs of model 125, optimizer 157 identifies one or more parameters that seem to be most effective for a given function. Optimizer 157 selects one or more of such parameters as optimized parameters 119. Optimizer 157 within simulation and calibration framework 140 outputs optimized parameters 119. Optimized parameters 119 may thereafter be used by model 125 when generating values of interest.

In examples where modeling platform 155 generates multiple surrogates 126, optimizer 157 may run simulations in parallel. For instance, work to be performed by surrogates 126 may be divided among multiple surrogate 126 runs, thereby potentially enabling assessments to be performed in less time.

Optimizer 157 may also run simulations in parallel to address the effect that randomness may have on each of the multiple surrogates 126. In other words, since there is some element of randomness to generating surrogates 126, that element of randomness may have an impact on how various surrogates 126 may perform. For example, when simulation and calibration framework 140 calibrates with surrogates 126, random numbers might be used at several points during the process. First, modeling platform 155 consumes random numbers during the parameter and Monte Carlo sampling to generate X, Y, and derivates. Then modeling platform 155 initializes the deep neural networks (surrogates 126) according to some random initializations (in a typical deep neural network architecture, these would be the weights and biases). Then, modeling platform 155 trains surrogates 126 by stochastic gradient descent methods with Adaptive Moment Optimization, which might consume additional random numbers. Once the surrogates have been constructed, optimizer 157 may use a global optimization method, which might also consume random numbers (global optimization may involve use of random numbers to construct a new population of parameter sets from the old one).

All these random numbers could be generated from either a single stream or from several streams with their own seed(s). A different choice of such seeds will, in general, lead to variations in results and thus training several surrogates 126 in parallel and optimizing against them may lead to different optimized parameters 119. Each of these sets of optimized parameters 119 might correspond to a differently accurate surrogate 126, leading to optimized parameter sets of different accuracies.

Accordingly, running independent constructions of surrogates 126 and optimizing over them starting with different seeds on different instances can be done in parallel. Given the multi-core nature of common commodity CPUs, modeling platform 155 one can obtain 5-10 (or any number of) replications at essentially the same running time as one replication; and on elastic compute units or larger server farms, this scales to even higher number of replications. Based on these metrics, simulation and calibration framework 140 can select a best seed or set of best seeds to define some robustification to the optimization, which may correspond to the robustness of the output values predicted by the corresponding surrogate model. That robustification will have results less dependent on any particular seed and likely perform better than an optimization run with only one particular seed.

Simulation and calibration framework 140 may employ a number of calibration approaches using multiple surrogates 126, including either of two possible robust calibration approaches: (1) a best seed approach, and (2) an ensemble approach. In the best seed approach, the best seed is selected based on some criteria, and the optimized parameters 119 are those corresponding to the surrogate 126 with the best seed. In the ensemble approach, simulation and calibration framework 140 forms an ensemble of surrogates 126, and the ensemble is used for analysis and selection of optimized parameters 119. Further details about the impact of randomness on surrogates 126 can be found in Polala & Hientzsch.

Techniques described herein may provide certain technical advantages. For instance, by applying differential machine learning to selection and/or optimization of optimal parameters using surrogates 126, simulation and calibration framework 140 may be able to identify optimal parameters while performing fewer computer simulations of model 125. Fewer simulations of model 125 translates into less use of computing resources and power consumption.

Further, by applying differential machine learning approaches to optimizing parameters, such as described in Polala & Hientzsch, it may be possible to train surrogates 126 to an appropriate level of accuracy with fewer training samples. Accordingly, techniques described herein are more efficient, less time-consuming, consume fewer computing resources and power than conventional techniques for optimizing parameters for use with a model.

Still further, by automating at least some aspects of the process of optimizing parameters for use with model 125, optimal parameters can be determined with less interaction with and/or involvement from domain experts, and through a more consistent, accurate, and efficient process. Accordingly, models that use parameters selected as described herein will operate more efficiently, effectively, and accurately than models using conventional processes for selecting optimal parameters.

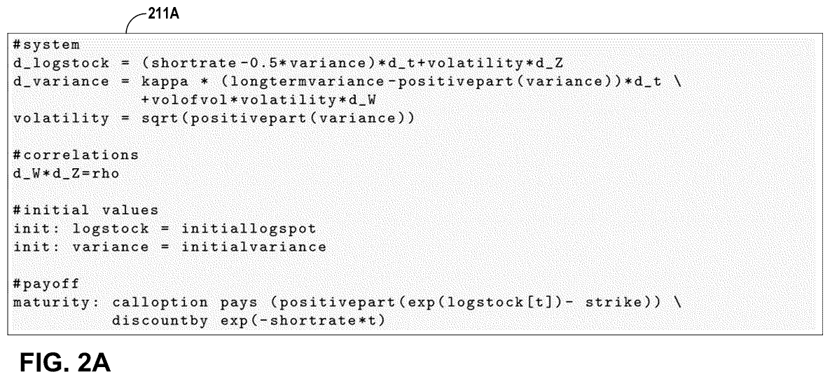

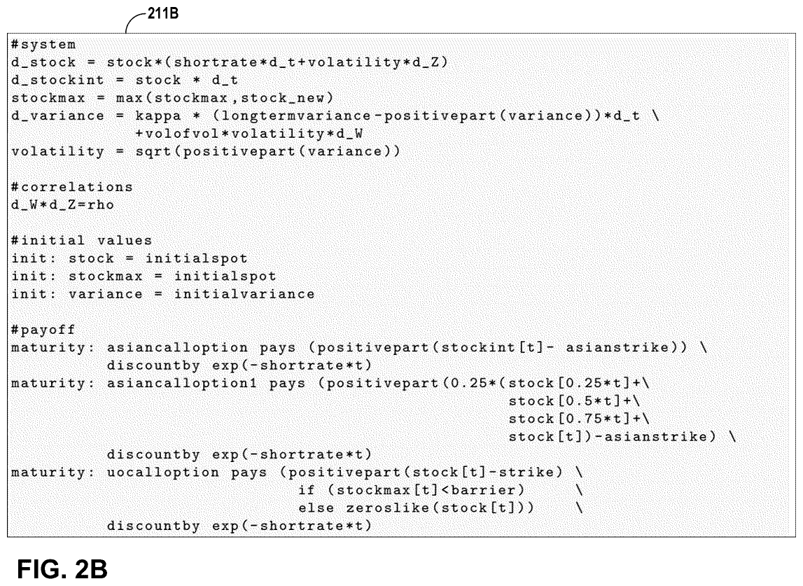

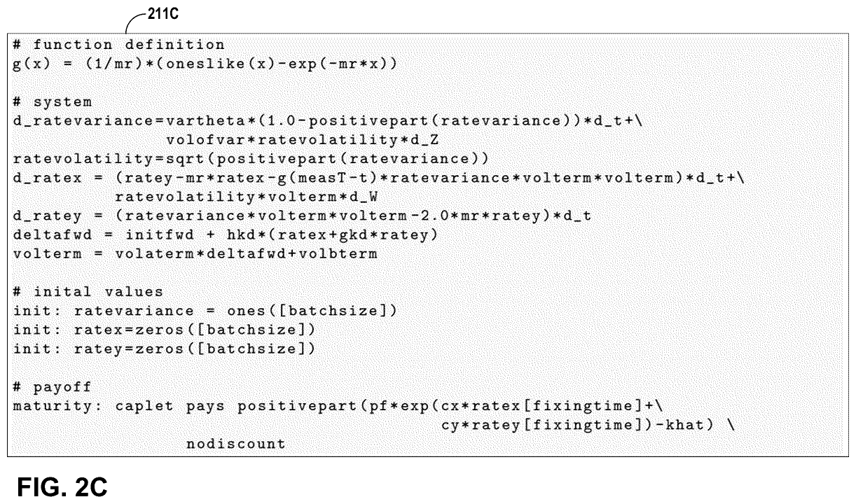

FIG. 2A through FIG. 2C illustrate example model scripts in accordance with one or more aspects of the present disclosure. FIG. 2A illustrates model script 211A, which specifies a log-Euler full truncation scheme for the Heston model to price a call option. FIG. 2B illustrates model script 211B, which shows pricing of three call options: one on a continuous Asian average, one on a discrete Asian average, and an up-and-out barrier one with observation at each time step. FIG. 2C illustrates model script 211B, specifying caplet pricing for a Cheyette model with stochastic volatility (Euler for Cheyette, Euler full truncation for Cox-Ingersoll-Ross).

Note that model script 211B of FIG. 2B pertains to a Heston model, like FIG. 2A, but is treated with a Euler full truncation scheme. The listing in FIG. 2B also demonstrates some features including Markovian updates for time-integral and maximum across time.

Each of model scripts 211A, 211B, and 211C (“model scripts 211”) may be specific examples of model script 111 illustrated as input to simulation and calibration framework 140 in FIG. 1. Using such model scripts 211, simulation and calibration framework 140 of FIG. 1 may enable a user or model practitioner to freely combine separately implemented-sub-stochastic differential equation systems, Markovian updates, functions and formulas, and payoffs. In some examples, each of model description text 211A, 211B, and 211C may be driven from Python input and enhanced by the Python interface.

Conventional techniques for simulating stochastic processes and functionals tended to require implementations of new classes. Such processes added complexity and maintenance burden. Simulation and calibration framework 140 of FIG. 1, on the other hand, enables a system to be simulated as described in a close-to-mathematical formulation. In general, the text of each of model scripts 211 in FIG. 2A through 2C has a one-to-one correspondence to the mathematical formulations of the corresponding model.

In some examples, a commercially-available parser (e.g., the Python parser) may be used to selectively generate appropriate abstract syntax trees and generate from the model script efficient implementations for TensorFlow and Numpy. Modeling platform 155 of simulation and calibration framework 140 (see FIG. 1), which may include or have access to TensorFlow, can generate fully differentiable TensorFlow computational graphs from one or more of model scripts 211 for an appropriate simulation of the system and to generate the corresponding payoffs. Any necessary derivatives can be added in the TensorFlow implementation by standard TensorFlow capabilities. Alternatively, or in addition, modeling platform 155 may implement a Numpy backend for debugging, tests, demonstrations and for direct simulation of the system and payoffs under Numpy. In general, simulation and calibration framework 140 may enable quick and efficient work with a wide range of models and payoffs based on relatively minimal input in a form close to mathematical notation.

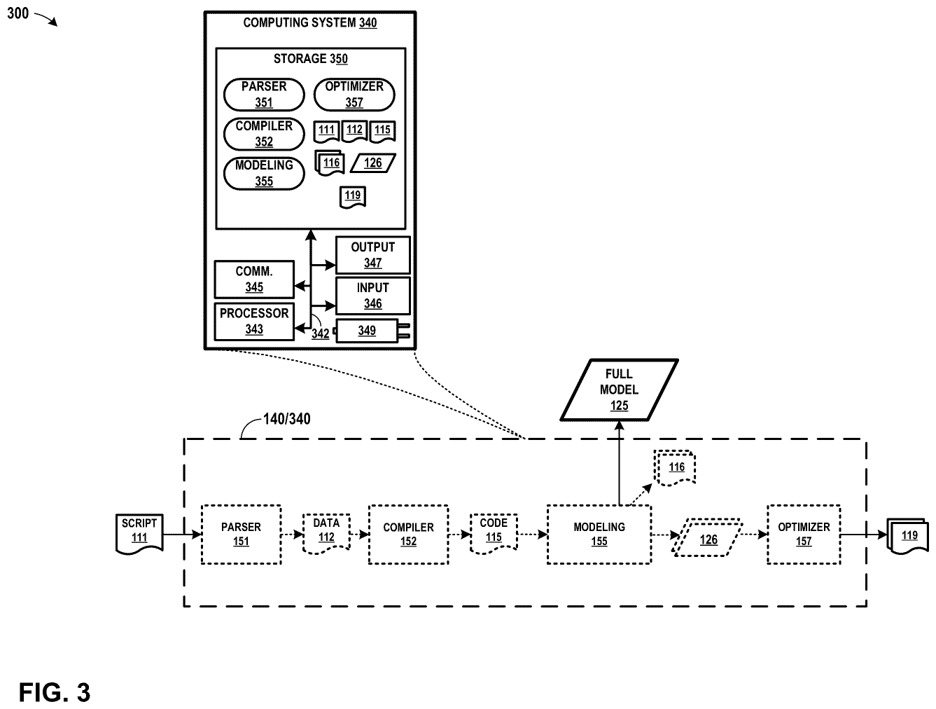

FIG. 3 is a block diagram illustrating an example system for calibrating parameters for a model, in accordance with one or more aspects of the present disclosure. System 300 of FIG. 3 includes simulation and calibration framework 140, which corresponds to simulation and calibration framework 140 illustrated in FIG. 1, and which includes some or all of the same elements of simulation and calibration framework 140 illustrated in FIG. 1. In general, like-numbered elements associated with illustrated in FIG. 3 thus correspond to elements illustrated in FIG. 1 and described in connection with FIG. 1.

Also illustrated in FIG. 3 is computing system 340, which illustrates an example implementation of simulation and calibration framework 140. Computing system 340 is illustrated in FIG. 3 to facilitate a description of certain components, modules, and other aspects of a computing system (i.e., computing system 340) that may be used to implement simulation and calibration framework 140. Computing system 340 is also illustrated in FIG. 3 to facilitate a description of how such a computing system may operate in accordance with techniques described herein. Since FIG. 3 is primarily described with reference to computing system 340, rather than with respect to elements within simulation and calibration framework 140, elements within simulation and calibration framework 140 are illustrated with dotted lines in FIG. 3.

For ease of illustration, computing system 340 is depicted in FIG. 3 as a single computing system. However, in other examples, computing system 340 may be implemented through multiple devices or computing systems distributed across a data center or multiple data centers. For example, one or more computing systems may implement functionality described herein as being performed by each of parser module 351, compiler module 352, modeling platform module 355, optimizer module 357, and/or any combination of such modules of simulation and calibration framework 140. Computing system 340 (or various modules illustrated in FIG. 3 as included within computing system 340) may be implemented through distributed virtualized compute instances (e.g., virtual machines, containers) of a data center, cloud computing system, server farm, and/or server cluster.

In FIG. 3, computing system 340 is shown with underlying physical hardware that includes power source 349, one or more processors 343, one or more communication units 345, one or more input devices 346, one or more output devices 347, and one or more storage devices 350. Storage devices 350 may include parser module 351, compiler module 352, modeling platform module 355, and optimizer module 357. One or more of the devices, modules, storage areas, or other components of computing system 340 may be interconnected to enable inter-component communications (physically, communicatively, and/or operatively). In some examples, such connectivity may be provided by through communication channels, which may include a system bus (e.g., communication channel 342), a network connection, an inter-process communication data structure, or any other method for communicating data. In general, computing system 340 of FIG. 3 may be considered an example implementation of simulation and calibration framework 140, but other implementations are possible.

Power source 349 of computing system 340 may provide power to one or more components of computing system 340. One or more processors 343 of computing system 340 may implement functionality and/or execute instructions associated with computing system 340 or associated with one or more modules illustrated herein and/or described below. One or more processors 343 may be, may be part of, and/or may include processing circuitry that performs operations in accordance with one or more aspects of the present disclosure.

One or more communication units 345 of computing system 340 may communicate with devices external to computing system 340 by transmitting and/or receiving data, and may operate, in some respects, as both an input device and an output device. In some or all cases, communication unit 375 may communicate with other devices or computing systems over a network (not shown in FIG. 3).

One or more input devices 346 may represent any input devices of computing system 340 not otherwise separately described herein, and one or more output devices 347 may represent any output devices of computing system 340 not otherwise separately described herein. Input devices 346 and/or output devices 347 may generate, receive, and/or process output from any type of device capable of outputting information to a human or machine. For example, one or more input devices 346 may generate, receive, and/or process input in the form of electrical, physical, audio, image, and/or visual input (e.g., peripheral device, keyboard, microphone, camera). Correspondingly, one or more output devices 347 may generate, receive, and/or process output in the form of electrical and/or physical output (e.g., peripheral device, actuator).

One or more storage devices 350 within computing system 340 may store information for processing during operation of computing system 340. Storage devices 350 may store program instructions and/or data associated with one or more of the modules described in accordance with one or more aspects of this disclosure. One or more processors 343 and one or more storage devices 350 may provide an operating environment or platform for such modules, which may be implemented as software, but may in some examples include any combination of hardware, firmware, and software. One or more processors 343 may execute instructions and one or more storage devices 350 may store instructions and/or data of one or more modules. The combination of processors 343 and storage devices 350 may retrieve, store, and/or execute the instructions and/or data of one or more applications, modules, or software. Processors 343 and/or storage devices 350 may also be operably coupled to one or more other software and/or hardware components, including, but not limited to, one or more of the components of computing system 340 and/or one or more devices or systems illustrated or described as being connected to computing system 340.

Parser module 351 and/or compiler module 352 may perform functions relating to translating model script 111 into code (e.g., code 115) that can be used by modeling platform module 355 to perform functions and/or the operations described herein. In some examples, parser module 351 and/or compiler module 352 may generate syntax trees and/or computational graphs (e.g., for use by TensorFlow). In general, parser module 351 and compiler module 352 perform functions corresponding to parser 151 of FIG. 1 and compiler 152 of FIG. 1, respectively.

Modeling platform module 355 may perform functions relating to executing simulations, generating samples, training machine learning models and/or neural networks, and generating surrogate models. Modeling platform module 355 may perform such functions based on code 115 generated by compiler module 352. Modeling platform module 355 may include or have access to one or more machine leaning model platforms or libraries, including TensorFlow and PyTorch. Modeling platform module 355 may perform functions corresponding to modeling platform 155 of FIG. 1.

Optimizer module 357 may perform functions relating to evaluating surrogates 126 to generate optimized or appropriate parameter values. Optimizer module 357 may, in general, perform functions corresponding to optimizer 157 of FIG. 1.

Data store 359 of computing system 340 may represent any suitable data structure or storage medium for storing information relating to model description text, parsed text, syntax trees, code, computational graphs, training samples, differentials, derivative values with respect to parameters, state, and/or time, parameter values, and optimized parameter values. The information stored in data store 359 may be searchable and/or categorized such that one or more modules within computing system 340 may provide an input requesting information from data store 359, and in response to the input, receive information stored within data store 359. Data store 359 may be primarily maintained by modeling platform module 355.

In an example that can be described in the context of FIG. 3, and in accordance with one or more aspects of the present disclosure, computing system 340 may generate code from a textual description of a model. For instance, input device 346 of computing system 340 detects input and outputs information about the input to parser module 351. Parser module 351 determines that the input corresponds to model script 111. Parser module 351 parses model script 111 to generate parsed data 112. Parser module 351 outputs information about parsed data 112 to compiler module 352. Compiler module 352 translates parsed data 112 into code 115.

Computing system 340 may use code 115 to instantiate model 125 and to select design parameters. For instance, continuing with the example being described in the context of FIG. 3, compiler module 352 outputs code 115 to modeling module 355. Modeling module 355 uses the code to instantiate, initialize, or identify an existing model 125, where model 125 is consistent with the mathematical equations represented by model script 111. Modeling platform module 355 selects a set of parameters from a parameter space. When selecting parameters, modeling platform module 355 may apply an adaptive sampling scheme to generate training samples 116, such as is described in connection with FIG. 1.

Computing system 340 may use the selected parameters to create training samples 116. For instance, still continuing with the example, modeling platform module 355 causes model 125 to predict an output or other quantity of interest based on the selected parameters. Modeling platform module 355 repeats the process of selecting parameters and using the selected parameters to generate an output from model 125. Eventually, after repeated simulations performed by model 125, modeling platform module 355 assembles a set of training samples 116. Each of training samples 116 include an output from model 125 (e.g., a payoff for a caplet or other financial instrument) and the input values that caused model 125 to generate the output. In some examples, training samples 116 might also include derivatives of the output values with respect to parameters and/or state.

Computing system 340 may generate one or more surrogates 126. For instance, again continuing with the example being described in the context of FIG. 3, modeling module 355 uses training samples 116 to generate one or more machine learning models, such as a surrogate 126, to predict an expected output of model 125 based on various state and parameter inputs. Specifically, modeling module 355 uses code 115 to train surrogate 126 to calculate a conditional expectation of a quantity of interest (e.g., price of a financial instrument) as a function of state and parameters. In some cases, surrogate 126 is a simplified model trained to predict the final state of model 125 (or a functional of the full trajectory of that process). In some examples, modeling module 355 may include or have access to a machine learning platform, such as TensorFlow. In such an example, code 115 may include computational graphs that can be used by TensorFlow to train a deep neural network. The surrogate 126 generated by modeling module 355 may be trained to predict the values that model 125 would be expected to produce if presented with the same state and parameter values.

Computing system 340 may use surrogate 126 to select optimized parameters. For instance, still with reference to FIG. 3, optimization module 357 runs a large number of simulations using surrogate 126. Optimizer module 357 observes the outputs generated by surrogate 126 to evaluate how predicted outputs of model 125 vary in response to differing parameters. Although surrogate 126 is trained to predict what values model 125 would generate, surrogate 126 is not the same as model 125, so the values produced by surrogate 126 are merely predictions, and might not be perfectly accurate reflections of output values that would have been generated by model 125 based on the same inputs. However, surrogate 126 is designed to be capable of generating output values much more quickly than model 125. The speed at which surrogate 126 operates enables more efficient sensitivity analysis and parameter calibration and/or optimizations much more quickly than if similar analysis were performed using model 125 directly. Accordingly, optimization module 357 is able to generate a sufficient amount of data within a reasonable time to enable an evaluation identifying desired parameters for use with model 125. Optimizer module 357 may, in some cases, identify such desired parameters as optimized parameters 119. In some examples, “optimal” or “optimized” parameters are those that tend to cause model 125 to produce a quantity of interest that is best for the given purpose (e.g., highest payoff for a financial instrument, fastest speed for a physics model, lowest risk for a risk model).

Computing system 340 may apply model 125 using the optimized parameters. For instance, once again with reference to FIG. 3, input device 346 of computing system 340 detects input and outputs information about the input to model 125. Model 125 determines that the input corresponds to a request to generate a value of interest based on the input. Model 125 uses optimized parameters 119 along with the input to generate the requested value of interest. Model 125 may, in connection with computing system 340 or another computing device (not specifically shown in FIG. 3), output information about the value of interest. For example, output device 347 of computing system 340 may be a display device, and the information about the value of interest may be presented to a user through a user interface displayed by the display device.

Modules illustrated in FIG. 3 (e.g., parser module 351, compiler module 352, modeling platform module 355, and optimizer module 357) and/or illustrated or described elsewhere in this disclosure may perform operations described using software, hardware, firmware, or a mixture of hardware, software, and firmware residing in and/or executing at one or more computing devices. For example, a computing device may execute one or more of such modules with multiple processors or multiple devices. A computing device may execute one or more of such modules as a virtual machine executing on underlying hardware. One or more of such modules may execute as one or more services of an operating system or computing platform. One or more of such modules may execute as one or more executable programs at an application layer of a computing platform. In other examples, functionality provided by a module could be implemented by a dedicated hardware device.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on a computing device.

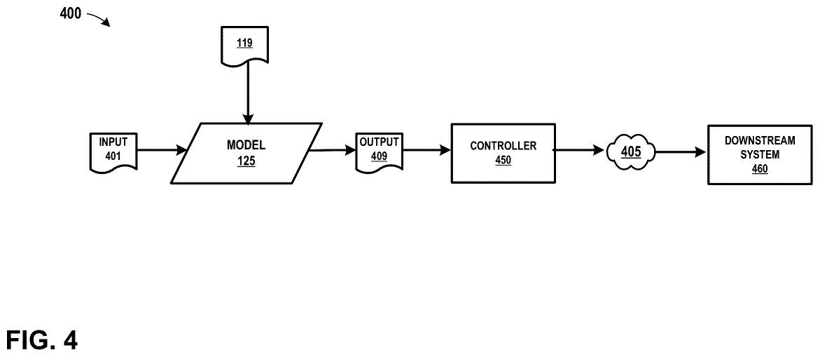

FIG. 4 is a conceptual diagram illustrating an example system that applies the output of a model to a downstream system to control the operation of the downstream system in accordance with one or more aspects of the present disclosure. System 400 of FIG. 4 includes model 125, a control system or controller 450, and downstream system 460. Controller 450 is capable of communicating with downstream system 460 over network 405. Model 125 may correspond to model 125 illustrated in FIG. 1 or FIG. 3. Model 125 may be used to generate a value of interest (e.g., model output 409) based on state, time, optimized parameters 119, and/or other values.

Controller 450 represents a system that receives an output from model 125 and acts on the output. In some examples, controller 450 controls the operation of another system, such as one or more downstream systems 460. Downstream system 460 may represent a system that operate based on inputs from controller 450. In some cases, one or more of such downstream systems 460 may be controlled, configured, or operated by controller 450 based on information controller 450 receives (e.g., model output 409) from model 125. Accordingly, one or more of downstream systems 460 may represent systems that perform operations or carry out commands issued by controller 450.

In operation, in the example of FIG. 4, model 125 receives input values 401. Optimized parameters 119, such as those determined by simulation and calibration framework 140 of FIG. 1, may be included within input values 401 or separately provided to model 125, as shown in FIG. 4. Model 125 generates, based on input values 401 and optimized parameters 119, model output 409. Model output 409 may represent or more values or quantities of interest relevant to operation of system 400 and/or downstream system 460. For example, in a financial application, model output 409 may represent a price or a payoff value. In a medical application, model output 409 may represent information about a diagnosis or information underlying a diagnosis. In an avionics application, model output 409 may represent information about the drag and/or lift of an aircraft.

Controller 450 may use model output 409 to control downstream system 460. For instance, in an example that can be described in the context of FIG. 4, controller 450 receives model output 409 from model 125. Controller 450 interprets model output 409 and determines one or more actions to take in response to model output 409. In a financial application, controller 450 may interpret model output 409 and determine that one or more trades should be placed in a financial market. In such an example, downstream system 460 may represent a computing system operating on an exchange or securities market, or operated by a market maker. Controller 450 outputs signals over network 405. Downstream system 460 receives the signals over network 405 and interprets the signals as commands to control the operation of downstream system 460. Downstream system 460 initiates one or more trades pursuant to the control signals and as indicated in model output 409. Accordingly, by outputting signals over network 405, controller 450 is capable of controlling the operation of downstream system 460 based on model output 409.

In an example that may apply in a medical application, controller 450 may interpret model output 409 and determine that image processing should be performed on an image captured by a medical device. In such an example, downstream system 460 may represent an image processing system. Accordingly, in this example, controller 450 outputs signals over network 405, which downstream system 460 interprets as commands to control the operation of the downstream system 460. Based on the commands, downstream system 460 performs image processing on the image captured by the medical device. In this way, controller 450 controls the operation of downstream system 460 by issuing commands to downstream system 460 that cause downstream system 460 to process the medical device image in an appropriate way.

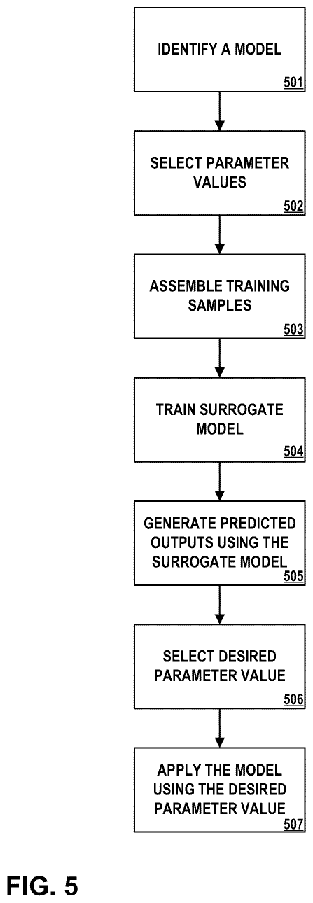

FIG. 5 is a flow diagram illustrating operations performed by an example framework 140 in accordance with one or more aspects of the present disclosure. FIG. 5 is described below within the context of framework 140 of FIG. 1. In other examples, operations described in FIG. 5 may be performed by one or more other components, modules, systems, or devices. Further, in other examples, operations described in connection with FIG. 5 may be merged, performed in a difference sequence, omitted, or may encompass additional operations not specifically illustrated or described.

In the process illustrated in FIG. 5, and in accordance with one or more aspects of the present disclosure, framework 140 may identify a model that generates an output based on a set of inputs (501). For example, parser 151 of framework 140 detects input that it interprets as model script 111. Parser 151 parses model script 111 to generate parsed data 112. Compiler 152 processes parsed data 112 to generate code 115. Modeling platform 155 uses the code to instantiate, identify, or otherwise gain access to model 125, where model 125 is a model described and/or specified by model script 111.

Framework 140 may select a first plurality of parameter values (502). For example, modeling platform 155 applies a parameter selection scheme to identify a set of parameter values. In some examples, modeling platform 155 applies an adaptive sampling scheme to select the first plurality of parameter values.

Framework 140 may assemble a set of training samples by observing outputs generated by the model in response to each of the first plurality of parameter values (503). For example, modeling platform 155 performs simulations using model 125 to generate output values and derivatives of those output values with respect to the identified set of parameter values. Modeling platform 155 generates training samples 116, where each sample includes inputs (including parameter values), at least one output value, and derivatives of output values with respect to the parameters.

Framework 140 may train, based on the set of training samples, a surrogate model (504). For example, modeling platform 155 uses training samples 116 to train surrogate 126 to predict outputs of 125. In some examples, modeling platform 155 trains surrogate 126 as a deep neural network in TensorFlow using computational graphs generated by modeling platform 155 or included within code 115.

Framework 140 may generate, using the surrogate model, predicted outputs of the model (505). For example, optimizer 157 of framework 140 performs simulations using surrogate 126 and records how predicted outputs of model 125 change in response to various parameter values in a second plurality of parameter values.

Framework 140 may select, based on the predicted outputs of the model, a desired parameter value (506). For example, optimizer 157 evaluates how the outputs of surrogate 126 change in response to the parameter values in the second plurality of parameter values. Based on the evaluation, optimizer 157 selects a desired or most desired or optimal parameter or set of parameters.

Framework 140 may apply the model, using the desired parameter value, to predict a value of interest for an input value (507). For example, once one or more desired parameters are identified, parameter calibration may be considered complete. Thereafter, model 125 may be used in production by applying model 125 to an input (along with the desired parameter(s)) to cause model 125 to generate a quantity of interest.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Further certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The disclosures of all publications, patents, and patent applications referred to herein are hereby incorporated by reference. To the extent that any such disclosure material that is incorporated by reference conflicts with the present disclosure, the present disclosure shall control.

For ease of illustration, only a limited number of devices (e.g., computing system 340, controller 450, downstream system 460, as well as others) are shown within the Figures and/or in other illustrations referenced herein. However, techniques in accordance with one or more aspects of the present disclosure may be performed with many more of such systems, components, devices, modules, and/or other items, and collective references to such systems, components, devices, modules, and/or other items may represent any number of such systems, components, devices, modules, and/or other items.

The Figures included herein each illustrate at least one example implementation of an aspect of this disclosure. The scope of this disclosure is not, however, limited to such implementations. Accordingly, other example or alternative implementations of systems, methods or techniques described herein, beyond those illustrated in the Figures, may be appropriate in other instances. Such implementations may include a subset of the devices and/or components included in the Figures and/or may include additional devices and/or components not shown in the Figures.

The detailed description set forth above is intended as a description of various configurations and is not intended to represent the only configurations in which the concepts described herein may be practiced. The detailed description includes specific details for the purpose of providing a sufficient understanding of the various concepts. However, these concepts may be practiced without these specific details. In some instances, well-known structures and components are shown in block diagram form in the referenced figures in order to avoid obscuring such concepts.

Accordingly, although one or more implementations of various systems, devices, and/or components may be described with reference to specific Figures, such systems, devices, and/or components may be implemented in a number of different ways. For instance, one or more devices illustrated herein as separate devices may alternatively be implemented as a single device; one or more components illustrated as separate components may alternatively be implemented as a single component. Also, in some examples, one or more devices illustrated in the Figures herein as a single device may alternatively be implemented as multiple devices; one or more components illustrated as a single component may alternatively be implemented as multiple components. Each of such multiple devices and/or components may be directly coupled via wired or wireless communication and/or remotely coupled via one or more networks. Also, one or more devices or components that may be illustrated in various Figures herein may alternatively be implemented as part of another device or component not shown in such Figures. In this and other ways, some of the functions described herein may be performed via distributed processing by two or more devices or components.

Further, certain operations, techniques, features, and/or functions may be described herein as being performed by specific components, devices, and/or modules. In other examples, such operations, techniques, features, and/or functions may be performed by different components, devices, or modules. Accordingly, some operations, techniques, features, and/or functions that may be described herein as being attributed to one or more components, devices, or modules may, in other examples, be attributed to other components, devices, and/or modules, even if not specifically described herein in such a manner.

Although specific advantages have been identified in connection with descriptions of some examples, various other examples may include some, none, or all of the enumerated advantages. Other advantages, technical or otherwise, may become apparent to one of ordinary skill in the art from the present disclosure. Further, although specific examples have been disclosed herein, aspects of this disclosure may be implemented using any number of techniques, whether currently known or not, and accordingly, the present disclosure is not limited to the examples specifically described and/or illustrated in this disclosure.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, or optical disk storage, magnetic disk storage, or other magnetic storage devices, flash memory, or any other medium that can be used to store desired program code in the form of instructions or data structures and that can be accessed by a computer. Also, any connection may properly be termed a computer-readable medium. For example, if instructions are transmitted from a website, server, or other remote source using a wired (e.g., coaxial cable, fiber optic cable, twisted pair) or wireless (e.g., infrared, radio, and microwave) connection, then the wired or wireless connection is included in the definition of medium. It should be understood, however, that computer-readable storage media and data storage media do not include connections, carrier waves, signals, or other transient media, but are instead directed to non-transient, tangible storage media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structure or any other structure suitable for implementation of the techniques described. In addition, in some examples, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, a mobile or non-mobile computing device, a wearable or non-wearable computing device, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperating hardware units, including one or more processors as described above, in conjunction with suitable software and/or firmware.

What is claimed is:

1. A method comprising:
identifying, by a framework and based on a model script, a model that generates an output based on a set of inputs, wherein the inputs include a plurality of parameters;
selecting, by the framework, a first plurality of parameter values;
assembling, by the framework, a set of training samples by observing outputs generated by the model in response to each of the first plurality of parameter values;
training, by the framework and based on the set of training samples, a surrogate model, wherein the surrogate model is trained to predict outputs of the model;
generating, by the framework and using the surrogate model, predicted outputs of the model, wherein each of the predicted outputs of the model is based on a different parameter value in a second plurality of parameter values;
selecting, by the framework and based on the predicted outputs of the model, a desired parameter value; and
applying the model, using the desired parameter value, to predict a value of interest for an input value.

2. The method of claim 1, further comprising:
receiving, by a control system, the value of interest;
interpreting, by the control system, the value of interest to determine an action to take; and
outputting, by the control system and over a network to a downstream system, a control signal to control the operation of the downstream system.

3. The method of claim 1, wherein selecting the first plurality of parameter values includes:
performing adaptive sampling to mitigate effects caused by variances across the first plurality of parameter values.

4. The method of claim 1, wherein assembling the set of training samples includes:
assembling training samples that each include a state value, a parameter value of the first plurality of parameter values, the observed output value, and a derivative of the observed output value with respect to the parameter value.

5. The method of claim 1, wherein training the surrogate model includes:
training a deep neural network using least square regression regularized with derivatives of the observed output values with respect to parameter values.

6. The method of claim 1, wherein training the surrogate model includes:
training a plurality of surrogate models, where each surrogate model is trained starting with a different random seed.

7. The method of claim 6, wherein generating predicted outputs of the model includes:
executing each of the surrogate models in parallel to generate different sets of predicted outputs of the model.

8. The method of claim 7, wherein selecting a desired parameter value includes:
selecting a desired one of the plurality of surrogate models based on an assessment of the robustness of the predicted outputs generated by each of the plurality of surrogate models; and
selecting the desired parameter value based on the predicted outputs generated by the desired surrogate model.

9. The method of claim 1, wherein selecting the desired parameter value includes:
selecting an optimal parameter value from the second plurality of parameter values, wherein the optimal parameter value tends to maximize the output from the model.

10. The method of claim 1, wherein predicting the value of interest includes:
predicting a payoff of an interest rate option contract.

11. A computing system comprising processing circuitry and a storage device, wherein the processing circuitry has access to the storage device and is configured to:
identify, based on a textual description, a model that generates an output based on a set of inputs, wherein the inputs include a plurality of parameters;
select a first plurality of parameter values;
assemble a set of training samples by observing outputs generated by the model in response to each of the first plurality of parameter values;
train, based on the set of training samples, a surrogate model, wherein the surrogate model is trained to predict outputs of the model;
generate, using the surrogate model, predicted outputs of the model, wherein each of the predicted outputs of the model is based on a different parameter value in a second plurality of parameter values;
select, based on the predicted outputs of the model, a desired parameter value; and
apply the model, using the desired parameter value, to predict a value of interest for an input value.

12. The computing system of claim 11, wherein the processing circuitry is further configured to:
receive the value of interest;
interpret the value of interest to determine an action to take; and
output, to a downstream system, a control signal to control the operation of the downstream system.

13. The computing system of claim 11, wherein to select the first plurality of parameter values, the processing circuitry is further configured to:
perform adaptive sampling to mitigate an effect caused by variances across the first plurality of parameter values.

14. The computing system of claim 11, wherein to assemble the set of training samples, the processing circuitry is further configured to:
assemble training samples that each include a state value, a parameter value of the first plurality of parameter values, the observed output value, and a derivative of the output value with respect to the parameter value.

15. The computing system of claim 11, wherein to train the surrogate model, the processing circuitry is further configured to:
train a deep neural network using least square regression regularized with derivatives of the observed output values with respect to the first plurality of parameter values.

16. The computing system of claim 11, wherein to train the surrogate model, the processing circuitry is further configured to:
train a plurality of surrogate models, where each is trained starting with a different random seed.

17. The computing system of claim 16, wherein to generate predicted outputs of the model, the processing circuitry is further configured to:
execute each of the surrogate models in parallel to generate different sets of predicted outputs of the model.

18. The computing system of claim 17, wherein to select a desired parameter value, the processing circuitry is further configured to:
select a desired one of the plurality of surrogate models based on an assessment of the robustness of the predicted outputs generated by each of the plurality of surrogate models; and
select the desired parameter value based on the predicted outputs generated by the desired surrogate model.

19. The computing system of claim 11, wherein to select the desired parameter value, the processing circuitry is further configured to:
select an optimal parameter value from the second plurality of parameter values.

20. A non-transitory computer-readable medium comprising instructions that, when executed, configure processing circuitry of a computing system to:
identify, based on a textual description, a model that generates an output based on a set of inputs, wherein the inputs include a plurality of parameters;
select a first plurality of parameter values;
assemble a set of training samples by observing outputs generated by the model in response to each of the first plurality of parameter values;
train, based on the set of training samples, a surrogate model, wherein the surrogate model is trained to predict outputs of the model;
generate, using the surrogate model, predicted outputs of the model, wherein each of the predicted outputs of the model is based on a different parameter value in a second plurality of parameter values;
select, based on the predicted outputs of the model, a desired parameter value; and
apply the model, using the desired parameter value, to predict a value of interest for an input value.
